(19) United States
(12) Patent Application Publication
(10) Pub. No.: US 2009/0087633 A1
(43) Pub. Date: Apr. 2, 2009

(54) Roofing membrane with improved edge flexibility

(76) Inventors: Troy Furgal, New Lenox, IL (US); Raymond C. Swann, Prairie Village, KS (US); Christopher James Griffin, Aurora, CO (US)

Correspondence Address: JOHNS MANVILLE, 10100 WEST UTE AVENUE, PO BOX 625005, LITTLETON, CO, 80162-5005, US

(21) Appl. No.: 11/906,217

(22) Filed: Oct. 1, 2007

(51) Int. Cl. B32B 7/02; B32B 37/12

(52) U.S. Cl. 428/213; 428/212; 156/280

(57) ABSTRACT

A roofing membrane with improved edge flexibility comprises a base reinforcement layer having a width W, a top reinforcement layer bonded to the base reinforcement layer, and a matrix coating the top reinforcement layer bonded to the base reinforcement layer. The top reinforcement layer has a width of about 80%±10% of width W. The matrix comprises one or more materials selected from the group consisting of bitumen, modified bitumen, one or more polymeric materials, and mixtures thereof.

### FIELD OF ART

The present disclosure relates to roofing membranes. More specifically, the present disclosure relates to roofing membranes with improved edge flexibility.

### BACKGROUND

Roofing membranes are conventionally made by coating a reinforcement layer with a bituminous and/or polymer matrix. The reinforcement layers are typically composed of woven and/or non-woven fiberglass and/or polyester. The reinforcement layers are often made of composites prepared by adhesively bonding layers of reinforcement materials also made of woven/non-woven fiberglass/polyester in various combinations. The reinforcement layers are made of the same materials across the full width or substantially the full width of the roofing membranes.

A conventional roofing membrane 10, as shown in FIG. 1, has a top surface 12 and a bottom surface 14 that are each defined by the length and width of the roofing membrane 10. The roofing membrane 10 has a lateral edge portion 16, typically called the selvage edge portion of the roofing membrane, which extends for the length of the roofing membrane. The selvage edge portion 16 of roofing membrane 10 is typically about 4 inches (101.6 millimeters) in width and when the roofing membrane 10 is installed on a roof, the top surface of a selvage edge portion 16 is overlapped and sealed to the underside of an opposite edge portion 18 of an adjacent roofing membrane 10 (see FIG. 2). The opposite edge portion 18 has substantially the same width as the selvage edge portion 16 and also extends for the length of the roofing membrane 10. Thus, when the roofing membrane 10 is installed on a roof, the top surface of the selvage edge portion 16 is covered by the opposite edge portion 18 of the adjacent roofing membrane while the remainder of the top surface 12 of the roofing membrane 10 is exposed to the weather.

In order to impart maximum tensile properties, the reinforcement layers are stiff, which makes it difficult for the opposite edge portion 18 of one roofing membrane 10 to conform to the selvage edge portion 16 of an adjacent roofing membrane 10 when the roofing membranes are installed. FIG. 2 is a cross sectional view of the area where an opposite edge portion 18 must flex over an adjacent selvage edge portion 16. Reference 20 in FIG. 2 represents the flex area. FIG. 3 is an illustration of a typical roofing membrane layout, where selvage edge portions 16 of adjacent roofing membranes 10 are overlapped by opposite edge portions 18 of the adjacent roofing membranes 10.

What is needed is roofing membranes that have opposite edge portions that are more flexible than those of conventional roofing membranes, which would improve the sealing performance of adjacent roofing membranes (e.g., to form a waterproof weather secure seam), which is critical to good roofing membrane performance.

### SUMMARY

Provided is a roofing membrane comprising a base reinforcement layer having a width W, a top reinforcement layer bonded to the base reinforcement layer, and a matrix coating the top reinforcement layer bonded to the base reinforcement layer. The top reinforcement layer has a width of about 80%±10% of width W. The matrix comprises one or more materials selected from the group consisting of bitumen, modified bitumen, one or more polymeric materials, and mixtures thereof.

Also provided is a method of making a roofing membrane, the method comprising providing a base reinforcement layer having a width W, bonding a top reinforcement layer to the base reinforcement layer, and coating the top reinforcement layer bonded to the base reinforcement layer with a matrix. The top reinforcement layer has a width of about 80%±10% of width W. The matrix comprises one or more materials selected from the group consisting of bitumen, modified bitumen, one or more polymeric materials, and mixtures thereof.

The presently disclosed roofing membranes, with a base reinforcement layer having a width W and a top reinforcement layer bonded to the base reinforcement layer and having a width of about 80%±10% of width W, have opposite edge portions that are more flexible than those of conventional roofing membranes. The improved edge flexibility allows for better conformation of the opposite edge portion of one roofing membrane onto the selvage edge portion of an adjacent roofing membrane when the roofing membranes are installed. The better conformation, in turn, improves the sealing performance of adjacent roofing membranes.

### BRIEF DESCRIPTION OF THE DRAWINGS

FIG. 1 is an illustration of a conventional roofing membrane.

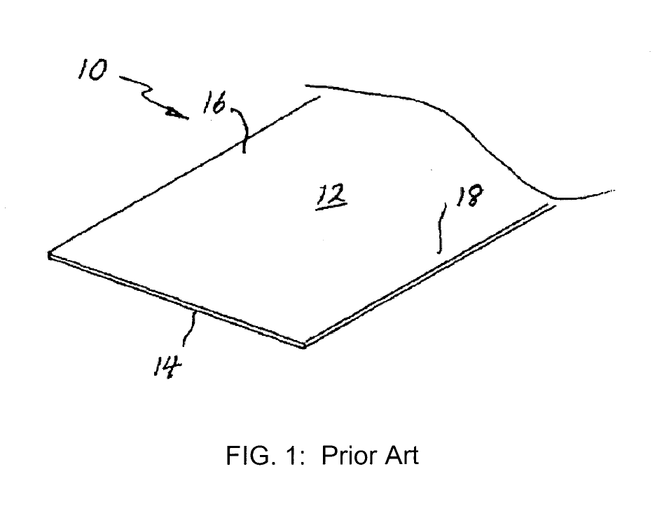

FIG. 2 is a cross sectional view of the overlapping area of adjacent conventional roofing membranes.

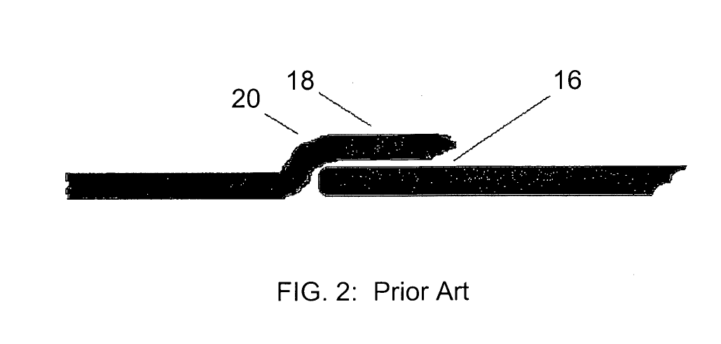

FIG. 3 is an illustration of a typical roofing membrane layout.

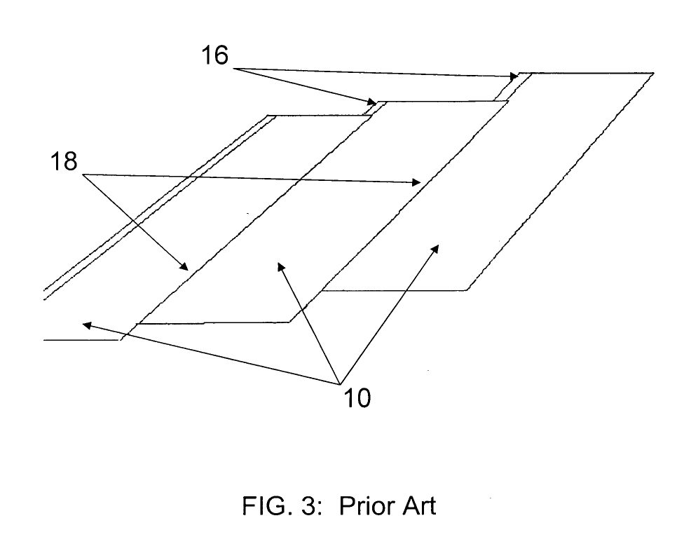

FIG. 4 is an illustration of the reinforcement layers of the presently disclosed roofing membrane.

FIG. 5 is a cross-sectional illustration of an embodiment of the presently disclosed roofing membrane.

FIG. 6 is a schematic side view of a production line that may be used to practice a method for fabricating the presently disclosed roofing membrane.

### DETAILED DESCRIPTION

Provided are roofing membranes that have opposite edge portions that are more flexible and compliant than those of conventional roofing membranes, which improve the sealing performance of adjacent roofing membranes.

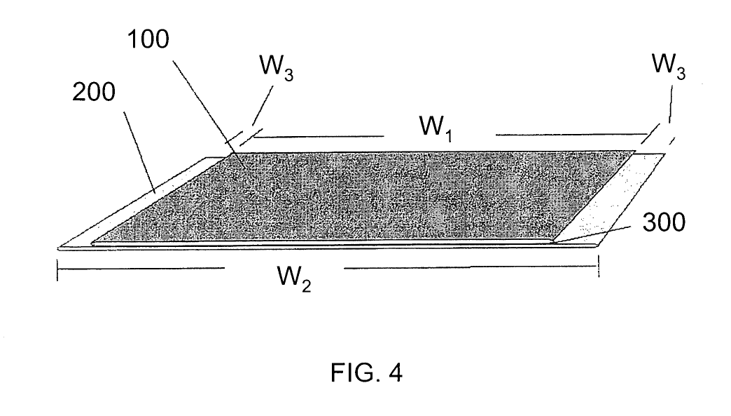

In particular, with reference to FIG. 4, the presently disclosed roofing membrane is comprised of a top reinforcement layer 100 bonded or laminated to a base reinforcement layer 200. The top reinforcement layer 100, which has a width W₁ that is about 80%±10% of the full width W₂ of the base reinforcement layer 200, can be a heavier, higher strength reinforcement layer than the base reinforcement layer 200. The top reinforcement layer 100 is then bonded, for example, adhesively bonded, to a base reinforcement layer 200 having a width W₂. The base reinforcement layer 200 is a lighter, less stiff/more flexible reinforcement layer. Reference 300 in FIG. 4 represents a glue or binder layer between top reinforcement layer 100 and base reinforcement layer 200. On top of the base reinforcing layer 200 and along each side of the top reinforcement layer 100 is an area, which has a width W₃ that is about 10%±5% of the full width W₂ of the base reinforcement layer 200, that does not contain reinforcement layer. The area along each side of the top reinforcement layer 100 having a width W₃ corresponds to the selvage edge portion of roofing membrane typically about 4 inches (101.6 millimeters) in width described above. Thus, FIG. 4 represents the top reinforcement layer 100 and base reinforcement layer 200 of the presently disclosed roofing membrane, without bituminous and/or polymer matrix or top surfacing.

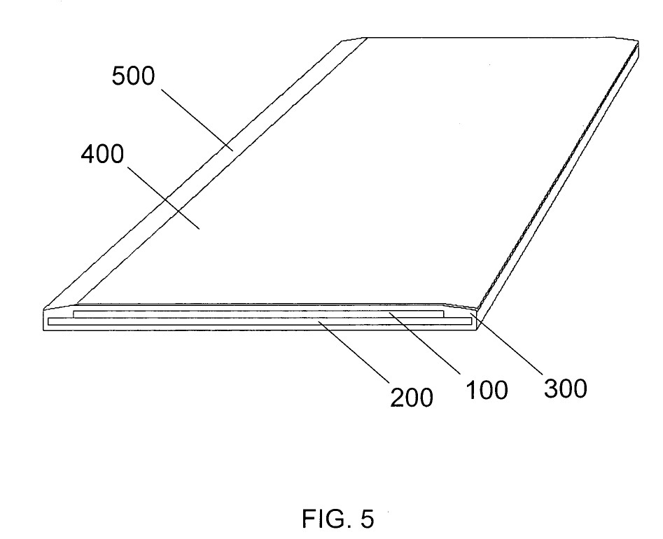

FIG. 5 is a cross-sectional view of the presently disclosed roofing membrane, wherein the top reinforcement layer 100 and bottom reinforcement layer 200 are coated with bituminous and/or polymer matrix 300. A top surfacing 400 on the roofing membrane does not cover a selvage edge portion 500 of the roofing membrane, which has a decreased thickness compared to a center location along a width of the roofing membrane. The opposite edge portion of the roofing membrane can also have a decreased thickness compared to a center location along a width of the roofing membrane.

As a result of the top reinforcement layer of the roofing membrane not being fully coextensive with the bottom reinforcement layer of the roofing membrane, the opposite edge portion and selvage edge portion of the roofing membrane, which comprise only a single reinforcement layer, are more flexible than if the roofing membrane were reinforced with a conventional strength and construction reinforcement layer, which carries the same reinforcement structure through the full width of the roofing membrane. The more flexible opposite edge portion of the roofing membrane allows for easier flexing of the opposite edge portion over an adjacent selvage edge portion. In an embodiment, the roofing membranes are 36 inches (914.4 millimeters) in width. In an embodiment, the roofing membranes are bituminous roofing membranes. In an embodiment, the roofing membranes are comprised of other roofing membrane materials used for building application such as, but not limited to, polyvinyl chloride (PVC), thermoplastic olefin (TPO), Hypalon® (chlorosulfonated polyethylene), or ethylene propylene diene monomer (EPDM) single ply roofing membranes.

Overlapping edge portions of adjacent roofing membranes can be adhered together to form watertight, weather-secure seams. While individual selvage edge portions and opposite edge portions each comprise only a single reinforcement layer (i.e., a base reinforcement layer without a top reinforcement layer), an opposite edge portion overlapping an adjacent selvage edge portion includes two (base) reinforcement layers. The roofing membranes can be self-adhering, meaning at least a portion of bottom surfaces of the roofing membranes have a self-adhering adhesive thereon that is used to adhere the roofing membranes to top surfaces of adjacent roofing membranes. The roofing membrane can have a top surfacing, e.g., the top surface is granule surfaced, except for a granule free lateral edge portion (i.e., selvage edge portion). When the roofing membranes are installed, the granule free lateral edge portions can be overlapped by and adhered to the bottom of granule surfaced opposite edge portions (i.e., opposition of the selvage edge portions) of adjacent roofing membranes. Thus, when adjacent roofing membranes are overlapped, the top surfaces of overlying opposite edge portions of roofing membranes, which are adhered to the top surfaces of selvage end portions of adjacent roofing membranes, are granule surfaced, and all exposed top surfaces of the installed roofing membranes are granule surfaced.

The roofing membrane can be, for example, about 10 to 15 meters long, about 880 to 1020 millimeters wide, and about 2 to 5 millimeters thick. The top surfacing can be about 730 to 970 millimeters wide and about 0.6 to 1.4 millimeters thick, with the selvage edge being about 50 to 150 millimeters wide. The selvage edge of the roofing membrane can have a thickness of about 70%±30% the thickness of the roofing membrane at a center location along a width of the roofing membrane, where the roofing membrane includes a base reinforcement layer, a top reinforcement layer, matrix, and optional top surfacing.

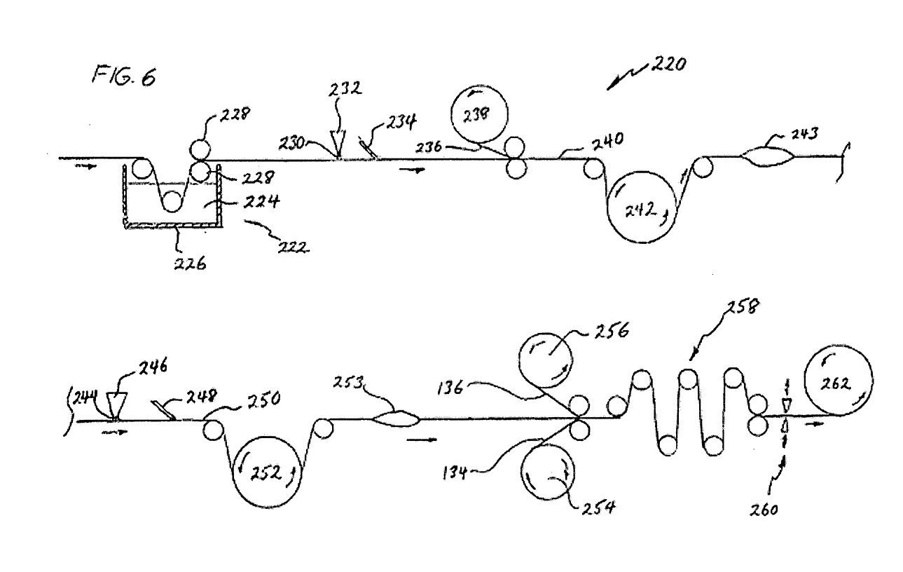

FIG. 6 schematically illustrates a typical manufacturing line 220 that could be used for making the presently disclosed roofing membranes. As shown in FIG. 6, the composite bonded reinforcing layers can be passed through a standard saturator/coater unit 222 or a standard saturator unit and a standard coater unit (not shown) where the composite bonded reinforcing layers are saturated and coated with asphalt 224 at temperatures typically between 300 to 425° F. The saturator/coater unit 222 of FIG. 6 includes a tank 226 that contains the asphalt 224 and squeeze rollers 228. The asphalt 224 can be any of the asphalt compositions discussed above and/or commonly used in the industry to make roofing membranes and typically contains asphalt and mineral fillers and can contain modifiers, such as thermoplastics (e.g., Amorphous Polypropylene (APP)), rubbers (e.g., Styrene-Butadiene-Styrene (SBS)), and other polymers, antioxidants, resins, oils, etc. Where the saturator and coater units are separate, the asphalts used in the saturator unit to saturate the composite bonded reinforcing layers and in the coater unit to coat the composite bonded reinforcing layers and build up the thickness of the saturated and coated substrate can have the same composition or different compositions.

As shown in FIG. 6, the composite bonded reinforcing layers is saturated and coated with the asphalt 224 by passing the composite bonded reinforcing layers through a pool of asphalt 224 in the tank 226. The thicknesses of the top and bottom asphalt layers of the asphalt saturated and coated composite bonded reinforcing layers and the overall thickness of the asphalt saturated and coated composite bonded reinforcing layers are then set by passing the saturated and coated composite bonded reinforcing layers between the spaced apart squeeze rollers 228. The spaced apart squeeze rollers 228 distribute the asphalt 224 evenly throughout the composite bonded reinforcing layers and over the top and bottom surfaces of the composite bonded reinforcing layers to form the built up layers of asphalt on the top and bottom surfaces of the composite bonded reinforcing layers.

In an embodiment, a polymer primer layer that is impermeable or substantially impermeable to the oils and other colored components of the asphalt 224 is then applied to the top surface of the top asphalt layer. The polymer primer material 230 that forms the polymer primer layer would typically be applied to the top surface of the top asphalt layer after the top asphalt layer has been cooled to a temperature below 300° F. To form the polymer primer layer of the roofing membrane, the polymer primer material 230 would be poured or sprayed across the entire width of the top surface of the top asphalt layer by an applicator 232. To form the polymer primer layer of the roofing membrane, the polymer primer material 230 would not be poured or sprayed onto the selvage edge portion, but would be poured or sprayed across the remaining width of the top surface of the top asphalt layer by an applicator 232 with a barrier preventing the primer material from flowing onto the selvage edge portion. The pool of polymer primer material 230 thus formed then passes beneath a doctor blade 234 that smoothes the top surface of the polymer primer material and forms the pool of polymer primer material into the polymer primer layer. The polymer primer layer is then typically air dried or cured prior to applying a highly reflective thermoplastic elastomeric sheet layer. While the technique shown for applying the polymer primer material 230 to the top surface of the top asphalt layer is a spread coating technique, it is contemplated that the polymer primer material 230 could be applied to the top surface of the top asphalt layer by other techniques commonly used in the industry, such as but not limited to, dip coating, roll coating, spray coating, and powder coating techniques.

In an embodiment, where a polymer primer material 230 is utilized to provide the membrane with a polymer primer layer, after a polymer primer layer is dried, a highly reflective thermoplastic elastomeric sheet 236 that forms a highly reflective thermoplastic elastomeric sheet layer can be applied to the top surface a polymer primer layer from a roll 238. In an embodiment, where a polymer primer material 230 is not utilized to form a polymer primer layer between the asphalt layer and a highly reflective thermoplastic elastomeric sheet layer of the roofing membrane, a highly reflective thermoplastic elastomeric sheet 236 that forms a highly reflective thermoplastic elastomeric sheet layer can be laid across the entire width of and directly onto the top surface of the top asphalt layer. In an embodiment, where a polymer primer material 230 is not utilized to form a polymer primer layer between the asphalt layer and a highly reflective thermoplastic elastomeric sheet layer of the roofing membrane, a highly reflective thermoplastic elastomeric sheet 236 that forms a highly reflective thermoplastic elastomeric sheet layer would not be laid onto the selvage edge portion, but would be laid across the remaining width of and directly onto the top surface of the top asphalt layer. A highly reflective thermoplastic elastomeric sheet layer is selected to have a desired thickness and smoothness that is sufficient to provide a highly reflective thermoplastic elastomeric sheet layer and the roofing membrane with necessary reflectance. While a highly reflective thermoplastic sheet 236 is shown being applied to the top surface of a polymer primer layer or the top surface of the asphalt layer from the roll 238 in FIG. 6, it is contemplated that a highly reflective thermoplastic elastomeric sheet 236 could be applied to the top surface of a polymer primer layer or the top surface of the asphalt layer by other techniques, such as but not limited to melt extrusion.

With a highly reflective thermoplastic elastomeric sheet layer applied to the top surface of the asphalt layer or the top surface of a polymer primer layer, the laminate 240 formed by the asphalt saturated and coated composite bonded reinforcing layers with a highly reflective thermoplastic elastomeric sheet layer or a polymer primer layer and a highly reflective thermoplastic elastomeric sheet layer passes around a first press drum 242. As the laminate 240 passes around the first press drum 242, the layers of the roofing membrane or the layers of the roofing membrane are pressed together to assure good adhesion between the layers. As or after the laminate 240 passes over the first press drum 242, the laminate is flipped (represented schematically by 243 in FIG. 6) so that the bottom surface of the bottom asphalt layer of the laminate is facing upward. This permits the application of surfacing materials (such as sand, other minerals (e.g., mica, talc, etc.), chemical release agents, and/or polymeric films) to the bottom surface of the laminate 240.

In FIG. 6, bottom surfacing material(s) 244 that form the bottom surface layer of the roofing membrane are shown being poured or sprayed onto the bottom surface of the bottom asphalt layer by an applicator 246. To form the bottom surface layer of the roofing membrane, the surfacing materials 244 would be poured or sprayed across the entire width of the bottom surface of the bottom asphalt layer by an applicator 246. To form the bottom surface layer of the roofing membrane, the surfacing materials 244 would not be applied to the opposite edge portion, but would be poured or sprayed across the remaining width of the bottom surface of the bottom asphalt layer by an applicator 246 with a barrier preventing the surfacing materials from flowing onto the opposite edge portion. The layer of surfacing material(s) thus formed then passes beneath a doctor blade 248 that smoothes the normally bottom surface of the surfacing material(s) and forms the layer of surfacing material(s) into a bottom surface layer having a desired thickness and smoothness.

The laminate 250 thus formed is then passed around a second press drum 252 where the surfacing materials 244 applied to the normally bottom surface of the asphalt layer of the laminate 250 are pressed into the bottom surface of the asphalt layer to assure good adhesion between the surfacing material(s) 244 and the asphalt layer. After the laminate 250 passes over the second press drum 252, the laminate 250 is then flipped (represented schematically by 253 in FIG. 6) and returned to its normal orientation.

After the application of the top layers and the bottom layers or the top layers and bottom layers to the top and bottom surfaces of the asphalt saturated and coated composite bonded reinforcing layers or the application of the top layers and the bottom layers or the top layers and bottom layers to the top and bottom surfaces of the asphalt saturated and coated composite bonded reinforcing layers, the laminate 252 formed is rapidly cooled by water-cooled rolls and/or water sprays to complete the manufacture of the roofing membrane. A bottom release sheet 134 is applied to the bottom surface layer and a top release sheet 136 is applied to the top surface of a highly reflective thermoplastic elastomeric sheet layer of the roofing membrane from rolls 254 and 256.

The roofing membrane is then fed through a looper or accumulator section 258 to permit the continuous movement of the roofing membrane during the winding and cutting operation. In the cutting and winding operation, the roofing membrane is periodically cut to a desired length or lengths by a cutting unit 260 and wound into rolls 262 for thermoplastic elastomeric sheet packaging, storage, and shipment to a job site.

Preferably, additional surfacing materials are not applied to the top surface of a highly reflective thermoplastic elastomeric sheet layer. However, after a highly reflective thermoplastic elastomeric sheet layer is applied to the top asphalt layer or a polymer primer layer the laminate 240 thus formed over the press drum 242, surfacing materials (such as roofing granules, sand, other minerals (e.g., mica, talc, etc.), chemical release agents, and/or polymeric films) can be applied to the top surface of a highly reflective thermoplastic elastomeric sheet layer.

While various embodiments have been described, it is to be understood that variations and modifications can be resorted to as will be apparent to those skilled in the art. Such variations and modifications are to be considered within the purview and scope of the claims appended hereto.

1. A roofing membrane comprising:
a base reinforcement layer having a width W;
a top reinforcement layer bonded to the base reinforcement layer, wherein the top reinforcement layer has a width of about 80%±10% of width W; and
a matrix coating the top reinforcement layer bonded to the base reinforcement layer, wherein the matrix comprises one or more materials selected from the group consisting of bitumen, modified bitumen, one or more polymeric materials, and mixtures thereof.

2. The roofing membrane of claim 1, wherein the top reinforcement layer has a higher strength compared to the base reinforcement layer.

3. The roofing membrane of claim 1, wherein the top reinforcement layer is adhesively bonded to the base reinforcement layer.

4. The roofing membrane of claim 1, wherein the top reinforcement layer is laminated to the base reinforcement layer.

5. The roofing membrane of claim 1, wherein:
the width of the top reinforcement layer is centered along the width of the base reinforcement layer; and
the top reinforcement layer and base reinforcement layer have equal lengths.

6. The roofing membrane of claim 1, wherein:
the matrix comprises one or more materials selected from the group consisting of polyvinyl chloride, thermoplastic olefin, chlorosulfonated polyethylene, ethylene propylene diene monomer, and combinations thereof; and
at least one of the top reinforcement layer and the base reinforcement layer is comprised of polyester, fiberglass, or a combination thereof.

7. The roofing membrane of claim 1, wherein at least one of the top reinforcement layer and the base reinforcement layer is comprised of a mat that is woven, non-woven, or partially woven and partially non-woven.

8. The roofing membrane of claim 1, wherein the roofing membrane is about 10 to 15 meters long, about 880 to 1020 millimeters wide, and about 2 to 5 millimeters thick.

9. The roofing membrane of claim 1, further comprising a top surfacing that does not cover a selvage edge of the roofing membrane.

10. The roofing membrane of claim 9, wherein the top surfacing is granule surfaced.

11. The roofing membrane of claim 9, wherein the roofing membrane is about 880 to 1020 millimeters wide, the top surfacing is about 730 to 970 millimeters wide, and the selvage edge is about 50 to 150 millimeters wide.

12. The roofing membrane of claim 1, wherein the top surfacing is about 0.6 to 1.4 millimeters thick.

13. The roofing membrane of claim 1, wherein the roofing membrane has a thickness T at a center location along a width of the roofing membrane, the roofing membrane comprising a selvage edge having a thickness of about 70%±30% of thickness T.

14. The roofing membrane of claim 1, wherein the roofing membrane is self-adhering.

15. A method of making a roofing membrane, the method comprising:
providing a base reinforcement layer having a width W;
bonding a top reinforcement layer to the base reinforcement layer, wherein the top reinforcement layer has a width of about 80%±10% of width W; and
coating the top reinforcement layer bonded to the base reinforcement layer with a matrix comprising one or more materials selected from the group consisting of bitumen, modified bitumen, one or more polymeric materials, and mixtures thereof.

16. The method of claim 15, wherein the top reinforcement layer has a higher strength compared to the base reinforcement layer.

17. The method of claim 15, comprising adhesively bonding the top reinforcement layer to the base reinforcement layer.

18. The method of claim 15, comprising laminating the top reinforcement layer to the base reinforcement layer.

19. The method of claim 15, further comprising centering the width of the top reinforcement layer along the width of the base reinforcement layer before bonding the top reinforcement layer to the base reinforcement layer.

20. The method of claim 15, further comprising applying a top surfacing to the roofing membrane, wherein the top surfacing does not cover a selvage edge of the roofing membrane.
